(19) United States
(12) Patent Application Publication
(10) Pub. No.: US 2026/0204495 A1
(43) Pub. Date: Jul. 16, 2026

(54) Sound-Producing Key Switch

(71) Applicant: DONGGUAN CITY KAIHUA ELECTRONICS CO.LTD, Dongguan (CN)

(72) Inventors: Fuxi WU, Dongguan (CN); Yuanfeng HU, Dongguan (CN)

(21) Appl. No.: 19/024,573

(22) Filed: Jan. 16, 2025

(51) Int. Cl. H01H 13/14

(52) U.S. Cl. CPC H01H 13/14; H01H 2215/03

(57) ABSTRACT

A sound-production key switch, comprising a base (1) and a guide core (2) provided on the base. At least one pressing bump (21) is provided on the guide core; a sound-production assembly (3) located on the side edge of the pressing bump is provided on the base; the sound-production assembly comprises a rotating push rod (31) rotatably provided on the base, and a metal dome (32) provided on the base and located on the side edge of the rotating push rod; and the rotating push rod comprises a rotating shaft (311) rotatably provided on the base, at least one push block (312) provided on the rotating shaft and corresponding to the pressing bump, and a knocking arm (313) provided on the rotating shaft and facing the metal dome.

### TECHNICAL FIELD

The invention relates to the field of key switches, in particular to a sounding key switch.

### TECHNICAL BACKGROUND

At present, there are many key switches that can be pressed to make sound. Because of the unreasonable sound structure design, the sound action of this key switch is inaccurate and the sound effect is poor.

At the same time, the sounding component and the conduction component installed in the key switch are separated from each other, which is easy to cause the problem that the sounding time and the conduction time are not synchronized, which affects the overall use effect and the user experience effect is poor.

### SUMMARY OF THE INVENTION

In view of the above shortcomings, the purpose of the present invention is to provide a sounding key switch, which can realize the function of pressing and sounding, and has accurate tapping and sounding action, crisp sound and good sounding effect. At the same time, the tapping sound action and the conduction action occur at the same time, that is, the synchronization effect of upper conduction and lower sound is realized, so that the key switch can be turned on and off, and the pressing sound function can also be realized.

The technical scheme adopted by the invention for achieving the above purpose is as follows:

The invention relates to a sounding key switch, which comprises a base and a guide core arranged on the base, wherein at least one pressing lug is arranged on the guide core, and a sounding component positioned on the side of the pressing lug is arranged on the base, and is characterized in that the sounding component comprises a rotating push rod rotatably arranged on the base and a pot of chips arranged on the base and positioned on the side of the rotating push rod. The rotary push rod comprises a rotating shaft rotatably arranged on the base, at least one pushing block arranged on the rotating shaft and corresponding to the pressing lug, and a striking arm arranged on the rotating shaft and facing the pot piece, wherein the pressing lug of the guide core moves downwards to act on the pushing block of the rotary push rod to urge the rotating shaft to rotate, thereby driving the striking arm to swing in the direction of the pot piece and striking the pot piece to make sound.

As a further improvement of the invention, a soft rubber pad is arranged between the percussion arm and the pot chip.

As a further improvement of the invention, an action protrusion is respectively formed on both sides of the soft rubber pad.

As a further improvement of the invention, a positioning block is arranged on the side of the pot chip far away from the striking arm, and a positioning projection is arranged on the side of the positioning block facing the pot chip.

As a further improvement of the invention, a supporting block for supporting the rotating shaft is formed on the base, a rotating clamping groove for the rotating shaft to be embedded and rotated is formed on the supporting block, an embedding groove for the pot piece to be embedded is formed on the base, and a movable groove for the percussion arm to swing through the embedding groove is formed on the supporting block.

As a further improvement of the present invention, a guide inclined plane is formed on the side of the pressing projection close to the pushing block.

As a further improvement of the invention, a positioning slot for the positioning block to be clamped is formed on the base.

As a further improvement of the invention, a conducting assembly is arranged on the base, which comprises a static piece and a moving piece respectively arranged on the base, wherein the static piece is provided with a static contact, the moving piece is provided with a moving contact corresponding to the static contact, and a pushing arm acting on the moving piece is arranged on the rotating shaft.

As a further improvement of the invention, the striking arm extends below the rotating shaft, and the pushing arm extends above the rotating shaft.

As a further improvement of the invention, the striking arm and the pushing arm are connected into a whole to form a swinging piece.

As a further improvement of the invention, the number of the pushing blocks is two, which are respectively arranged on both sides of the swinging piece.

As a further improvement of the invention, a return spring is arranged between the guide core and the base, and an upper cover is arranged on the base, and the upper end of the guide core penetrates through the upper cover for pressing.

The invention has the beneficial effects that:
(1)Through the combination of a rotating push rod with a special structural design and a pot chip, the sound-making function can be realized by pressing, and the sound-making action is accurate, the sound is crisp and the sound-making effect is good.
(2)The rotating push rod with special structural design is matched with the conduction component, and the knocking arm and the pushing arm swing at the same time during the rotation of the rotating shaft of the rotating push rod, so that the knocking sound action and the conduction action of the conduction component occur at the same time, that is, the synchronous effect of upper conduction and lower sound is realized, so that the key switch can be turned on and off, and the pressing sound function can also be realized.

The above is an overview of the technical scheme of the invention, and the invention will be further explained with the attached drawings and specific embodiments.

### BRIEF DESCRIPTION OF DRAWINGS

FIG. 1 is an exploded view of the present invention;

FIG. 2 is a structural schematic diagram of a part of the present invention;

FIG. 3 is a schematic structural diagram of the base in the present invention;

FIG. 4 is a sectional view of the present invention;

FIG. 5 is a schematic structural diagram of the rotary push rod in the present invention;

FIG. 6 is a schematic structural diagram of the soft rubber pad in the present invention;

FIG. 7 is a structural schematic diagram of another part of the present invention;

FIG. 8 is a schematic diagram of the external structure of the present invention.

### EMBODIMENT

In order to further illustrate the technical means and effects adopted by the present invention to achieve the predetermined purpose, the specific embodiments of the present invention will be described in detail with the attached drawings and preferred embodiments.

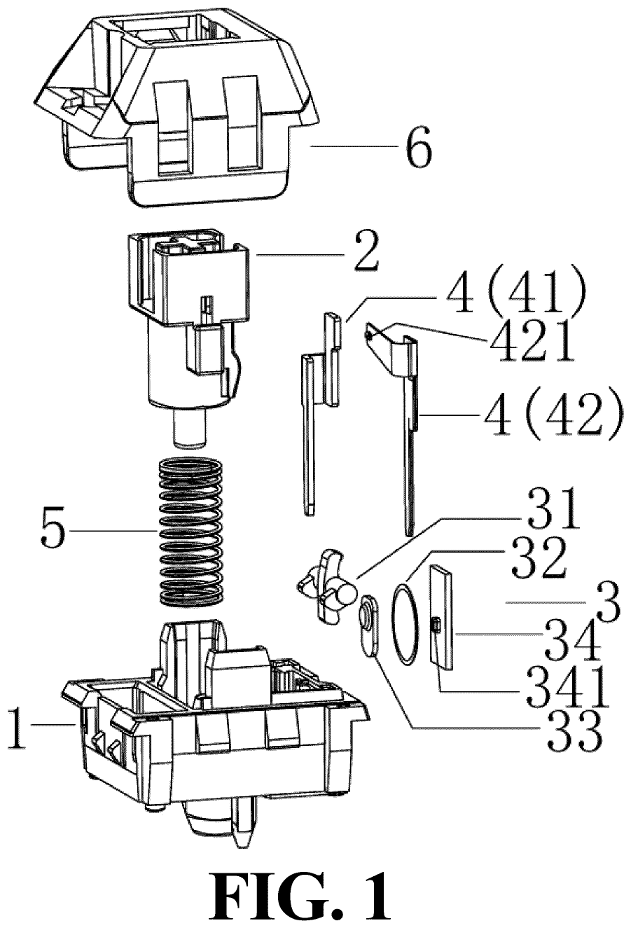

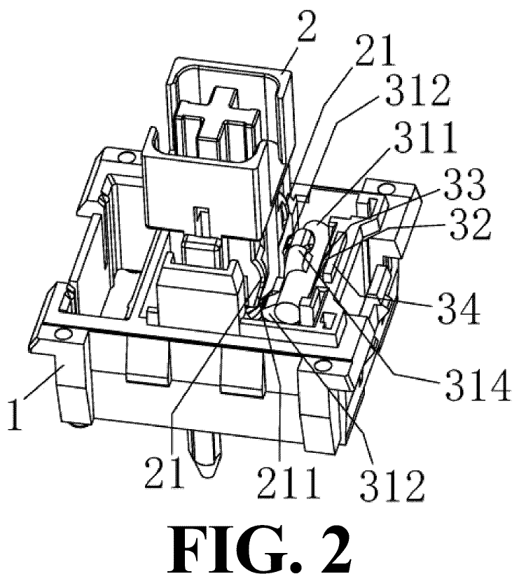

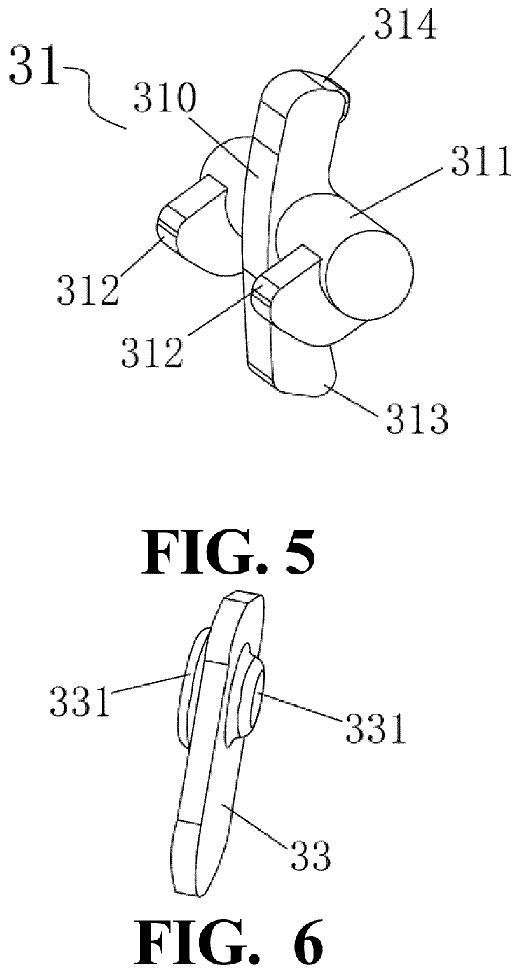

Please refer to FIG. 1 and FIG. 2. An embodiment of the present invention provides a sounding key switch, which comprises a base 1 and a guide core 2 arranged on the base 1. At least one pressing projection 21 is arranged on the guide core 2, and a sounding assembly 3 located at the side of the pressing projection 21 is arranged on the base 1. The sounding assembly 3 comprises a rotating push rod 31 rotatably arranged on the base 1 and a pot piece 32 arranged on the base 1 and located at the side of the rotating push rod 31. Specifically, as shown in FIG. 5, the rotary push rod 31 includes a rotating shaft 311 rotatably arranged on the base 1, at least one pushing block 312 arranged on the rotating shaft 311 and corresponding to the pressing projection 21, and a striking arm 313 arranged on the rotating shaft 311 and facing the pot piece 32. The pushing block 312 of the rotating push rod 31 is moved downwards by the pressing projection 21 of the guide core 2, which urges the rotating shaft 311 to rotate, thereby driving the knocking arm 313 to swing in the direction of the pot piece 32 and knocking the pot piece 32 to make sound.

When the pressing guide core 2 moves down, the pressing projection 21 on the guide core 2 acts on the pushing block 312 of the rotating push rod 31 with the downward movement, pushing the pushing block 312 outward, as shown in FIG. 2, which urges the rotating shaft 311 to rotate counterclockwise. Correspondingly, the rotation of the rotating shaft 311 drives the striking arm 313 to swing in the direction of the pot piece 32 until it strikes the pot piece 32 to make sound, thus realizing the pressing sound function, and at the same time, the pot piece 32 is elastically deformed. When the pressing of the guide core 2 is released, the guide core 2 moves upward to reset, and the pressing projection 21 is separated from the pushing block 312 with the upward movement. Under the elastic restoring force of the pot piece 32, the striking arm 313 swings in the opposite direction, driving the rotating shaft 311 to rotate clockwise to reset. Through the special structural design of the sounding assembly 3 composed of the rotating push rod 31 and the pot piece 32, the pressing sounding function can be realized, and the knocking action is accurate and the sound is crisp.

In this embodiment, as shown in FIGS. 1, 2 and 4, a soft rubber pad 33 is arranged between the striking arm 313 and the pot piece 32. When the striking arm 313 swings towards the pot chip 32, the striking arm 313 acts on the pot chip 32 through the soft rubber pad 33, that is, the soft rubber pad 33 directly strikes the pot chip 32 instead of the striking arm 313 directly striking the pot chip 32. Because the soft rubber pad 33 has the characteristics of elasticity and softness, the service life of the pot chip 32 and the whole product can be prolonged while striking.

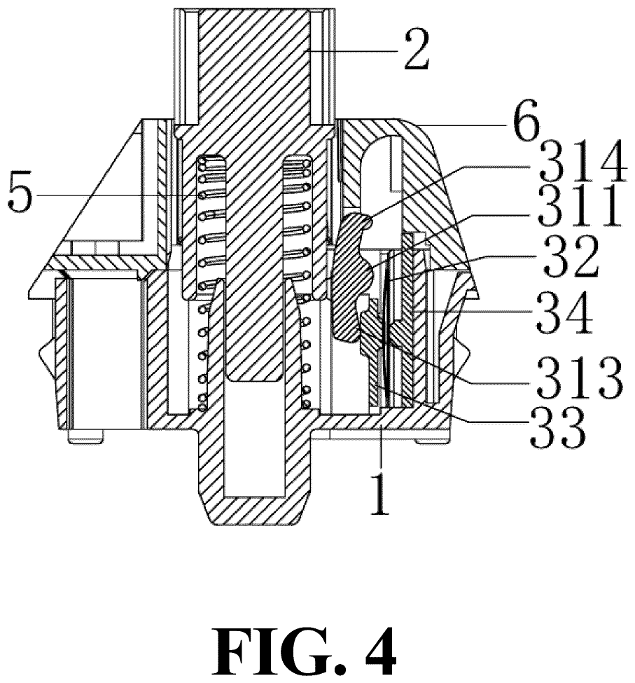

At the same time, in order to make the tapping action more accurate, as shown in FIGS. 4 and 6, in this embodiment, an action protrusion 331 is formed on both sides of the soft rubber pad 33. When the tapping action occurs, the tapping arm 313 directly acts on one side of the action projection 331, and the other side of the action projection 331 directly acts on the pot piece 32, so that the action point is accurate and the accuracy of the tapping action is improved.

In this embodiment, as shown in FIG. 1, FIG. 2 and FIG. 4, a positioning block 34 is arranged on the side of the pot piece 32 far away from the striking arm 313, and a positioning protrusion 341 is arranged on the side of the positioning block 34 facing the pot piece 32. A positioning slot 13 is formed on the base 1 for the positioning block 34 to engage. When the pot piece 32 is struck, the pot piece 32 will be deformed, and the deformation of the pot piece 32 is controlled by the positioning block 34 with the positioning protrusion 341, that is, the stroke of the pot piece 32 is positioned, which is beneficial to improving the accuracy of the striking action.

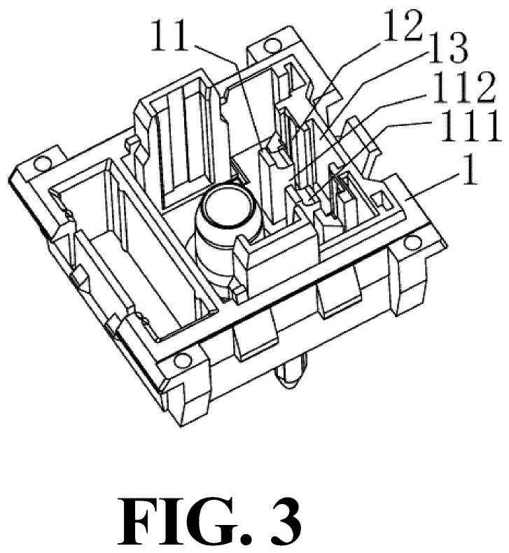

As for the installation of the rotating push rod 31 and the pot piece 32, as shown in FIGS. 2 and 3, in this embodiment, a supporting block 11 for supporting the rotating shaft 311 is formed on the base 1, and a rotating slot 111 for the rotating shaft 311 to be embedded and rotated is formed on the supporting block 11. An embedding groove 12 for embedding the pot pieces 32 is formed on the base 1, and a movable groove 112 is formed on the support block 11, which penetrates into the embedding groove 12 and allows the knocking arm 313 to swing. Specifically, the rotating shaft 311 in this embodiment is cylindrical, and correspondingly, the rotating slot 111 is a matching arc slot. When the pressing projection 21 on the guide core 2 moves downward to push the pushing block 312 outward, the rotating shaft 311 rotates counterclockwise in the rotating slot 111, and at the same time, the knocking arm 313 is driven to swing in the direction of the pot piece 32 through the movable slot 112, thereby knocking the pot piece 32. Due to the special groove structure design on the base 1, the rotating push rod 31 and the pot piece 32 can move accurately after being installed.

In order that the pressing projection 21 can better act on the pushing block 312, as shown in FIG. 2, a guide inclined surface 211 is formed on the side of the pressing projection 21 close to the pushing block 312. Due to the existence of the guide inclined surface 211 of the pressing projection 21, when the guiding core 2 drives the pressing projection 21 to move down, the guide inclined surface 211 can gradually push the pushing block 312 outward, thus achieving a stable force on the rotating shaft 311.

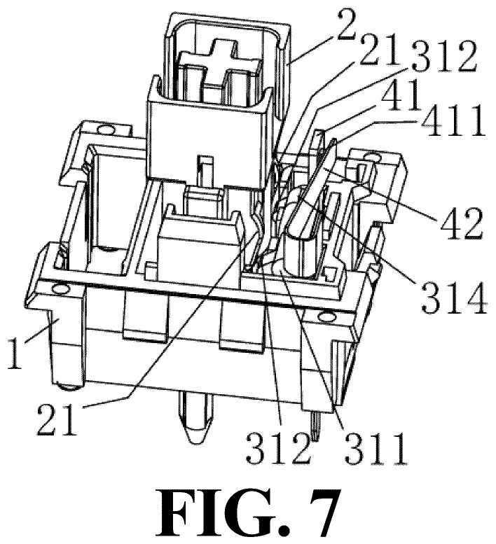

In this embodiment, as shown in FIGS. 1 and 7, a conducting assembly 4 is arranged on the base 1. Specifically, the conducting assembly 4 includes a stationary piece 41 and a movable piece 42 respectively arranged on the base 1. The stationary piece 41 is provided with a stationary contact 411, the movable piece 42 is provided with a movable contact 421 corresponding to the stationary contact 411, and a push arm 314 acting on the movable piece 42 is arranged on the rotating shaft 311. When the guide core 2 is at rest and not pressed, the push arm 314 pushes the moving piece 42 outward, so that the moving contact 421 of the moving piece 42 is separated from the stationary contact 411, and the conductive assembly 4 is turned off, that is, the key switch is in the off state. When the pressing guide core 2 moves down, the pressing projection 21 on the guide core 2 acts on the pushing block 312 of the rotating push rod 31 with the downward movement, pushing the pushing block 312 outward, as shown in FIG. 7, which urges the rotating shaft 311 to rotate counterclockwise. Correspondingly, the rotation of the rotating shaft 311 drives the striking arm 313 to swing in the direction of the pot piece 32 until it strikes the pot piece 32 and makes sound. At the same time, the rotation of the rotating shaft 311 drives the push arm 314 to swing in the direction of the guide core 2, so that the push arm 314 releases the outward force on the moving piece 42, and then the moving piece 42 moves closer to the stationary piece 41 due to the reset, so that the moving contact 421 contacts the stationary contact 411, and the conducting assembly 4 is conducted, that is, the key switch is in a conducting state. When the pressing of the guide core 2 is released, the guide core 2 moves upward to reset, and the pressing projection 21 is separated from the pushing block 312 along with the moving upward. Under the elastic restoring force of the pot piece 32, the striking arm 313 swings reversely to drive the rotating shaft 311 to rotate clockwise to reset, then the pushing arm 314 swings outward to reset, and acts on the moving piece 42 again, so that the moving contact 421 of the moving piece 42 is separated from the stationary contact 411, and the key switch is restored to the off state.

In this embodiment, as shown in FIG. 5, the striking arm 313 extends below the rotating shaft 311, and the pushing arm 341 extends above the rotating shaft 311. Meanwhile, the striking arm 313 and the pushing arm 314 are integrated to form a swinging member 310. During the rotation of the rotating shaft 311, the swinging member 310 is driven to swing, that is, the knocking arm 313 and the pushing arm 314 swing at the same time, so that the knocking sound action and the conducting action of the conducting assembly 4 occur at the same time, thereby realizing the on-off function of the key switch and the pressing sound function.

In this embodiment, in order to improve the rotation balance of the rotary push rod 31, the number of the push blocks 312 is two, which are respectively arranged on both sides of the swinging member 310. Correspondingly, the number of the pressing projections 21 is also two, and they correspond to the pushing blocks 312 one by one. When the guide core 2 moves down, the push block 312 is acted on by the pressing projection 21 from both sides, so that the rotary push rod 31 rotates stably and the rotational balance is improved.

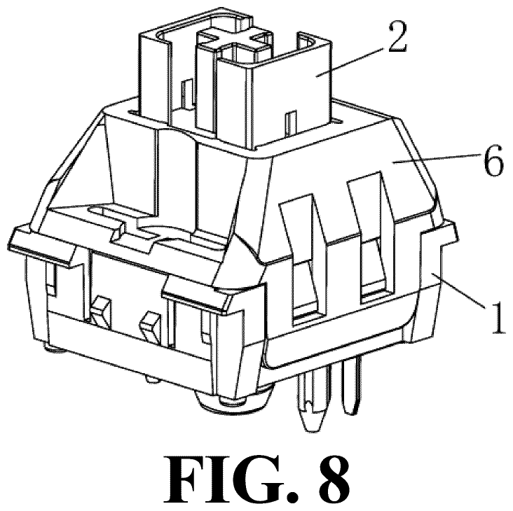

In a specific key switch product, as shown in FIG. 8, a reset spring 5 is arranged between the guide core 2 and the base 1, and the reset spring 5 provides elastic restoring force for the upward reset of the guide core 2; Meanwhile, an upper cover 6 is arranged on the base 1, and the upper end of the guide core 2 penetrates through the upper cover 6 for pressing.

The above is only a preferred embodiment of the present invention, and does not limit the technical scope of the present invention, so other structures obtained by adopting the same or similar technical features as the above embodiment of the present invention are within the protection scope of the present invention.

1. The invention relates to a sounding key switch, which comprises a base and a guide core arranged on the base, wherein at least one pressing lug is arranged on the guide core, and a sounding component positioned at the side of the pressing lug is arranged on the base. Characterized in that the sounding assembly comprises a rotating push rod rotatably arranged on the base, and a pot-shaped piece arranged on the base and located at the side of the rotating push rod, wherein the rotating push rod comprises a rotating shaft rotatably arranged on the base, at least one pushing block arranged on the rotating shaft and corresponding to the pressing lug, and a knocking arm arranged on the rotating shaft and facing the pot-shaped piece; the pressing lug of the guide core moves downwards to act on the pushing block of the rotating push rod, so that the rotating shaft rotates, thereby driving the knocking arm to swing towards the pot-shaped piece, and tap the pot piece to make a sound.

2. The sounding key switch according to claim 1 is characterized in that a soft rubber pad is arranged between the percussion arm and the pot piece.

3. The voice button switch according to claim 2, characterized in that two sides of the soft rubber pad are respectively formed with an action protrusion.

4. The sounding key switch according to claim 1 is characterized in that a positioning block is arranged on the side of the pot piece far away from the striking arm, and a positioning projection is arranged on the side of the positioning block facing the pot piece.

5. The sound button switch according to claim 1, characterized in that a supporting block for supporting the rotating shaft is formed on the base, a rotating clamping groove for the rotating shaft to be embedded and rotated is formed on the supporting block, an embedding groove for the pot chip is formed on the base, and a movable groove for the percussion arm to swing is formed on the supporting block.

6. The sounding key switch according to claim 1, characterized in that a guide inclined plane is formed on the side of the pressing projection close to the pushing block.

7. The voice button switch according to claim 4, characterized in that a positioning slot for the positioning block to be clamped is formed on the base.

8. The sounding key switch according to claim 1 is characterized in that a conducting component is arranged on the base, and the conducting component comprises a static piece and a moving piece which are respectively arranged on the base; the static piece is provided with a static contact; the moving piece is provided with a moving contact corresponding to the static contact; and a push arm acting on the moving piece is arranged on the rotating shaft.

9. The sounding key switch according to claim 8, wherein the striking arm extends below the rotating shaft and the pushing arm extends above the rotating shaft.

10. The sounding key switch according to claim 9, characterized in that the striking arm and the pushing arm are connected into a whole to form a swinging piece.

11. The sounding key switch according to claim 10 is characterized in that the number of the push blocks is two, which are respectively arranged on both sides of the swinging piece.

12. The sounding key switch according to claim 1 is characterized in that a return spring is arranged between the guide core and the base, and an upper cover is arranged on the base, and the upper end of the guide core penetrates through the upper cover for pressing.
